(19) United States
(12) Patent Application Publication
(10) Pub. No.: US 2008/0015875 A1
(43) Pub. Date: Jan. 17, 2008

(54) SUPPLY CHAIN TRACKING AND MANAGEMENT

(76) Inventor: Gary Gardner, Dallas, TX (US)

Correspondence Address: CARSTENS & CAHOON, LLP, P O BOX 802334, DALLAS, TX, 75380, US

(21) Appl. No.: 11/457,984

(22) Filed: Jul. 17, 2006

(51) Int. Cl. G06Q 10/00; G06Q 30/00

(52) U.S. Cl. 705/1

(57) ABSTRACT

The present invention provides a method, program product and system for distributing merchandise. The invention involves assigning a unique identifier to a product as well as each copy of the product. The invention also assigns unique identifiers to all distributors of the product. When a copy of the product is sold from the manufacturer to an end user through the distributors, the unique identifier of that copy is matched with the unique identifiers of all distributors who were involved in supplying the copy to the end user. Sale of that particular item is recorded at the retail point of sale using an identification method such as RFID, which is then recorded by an accounting server. The distributors in the supply chain that were involved in selling that particular copy of the product are then paid according to a pre-determined schedule.

### TECHNICAL FIELD

The present invention relates generally to a method for tracking the distribution of products through a supply chain, and more specifically to a method for calculating appropriate commissions for parties within a supply chain who are responsible for bringing an item from the manufacturer to the end customer.

### BACKGROUND OF THE INVENTION

Currently, there are several channels for the distributing products. Probably the most common form of distribution comprises the product manufacturer first selling the product to a distributor, who then sells it to a retail outlet. The retail outlet in turn sells this product to consumers. More established manufacturers with greater logistical resources may not need a distributor and instead sell the product directly to a retail outlet.

Alternatively, the manufacturer may consign inventory to a retail outlet. The retail outlet sells the product to consumers and then pays the content provider at a later date, sometimes months following the sale. In those situations where a distributor is involved, the distributor may consign inventory to the retail outlets, rather than the manufacturer doing so. In this case, the manufacturer is paid up front by the distributor, and the distributor is paid at a later date by the retailers, again sometimes months following the sale.

The increasing complexity of global product distribution and the greater role played by Internet sales makes it increasingly difficult to identify the distributors and retailers who are responsible for delivering a particular item from the manufacturer to the end customer. This is particularly important when determine sales commission for parties within a particular supply chain.

### SUMMARY OF THE INVENTION

The present invention provides a method, program product and system for distributing merchandise. The invention involves assigning a unique identifier to a product as well as each copy of the product. The invention also assigns unique identifiers to all distributors of the product. When a copy of the product is sold from the manufacturer to an end user through the distributors, the unique identifier of that copy is matched with the unique identifiers of all distributors who were involved in supplying the copy to the end user. Sale of that particular item is recorded at the retail point of sale using an identification method such as RFID, which is then recorded by an accounting server. The distributors in the supply chain that were involved in selling that particular copy of the product are then paid according to a pre-determined schedule.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 illustrates a process flow for a billing system in accordance with an embodiment of the present invention; and

FIG. 4 shows the process flow for using the billing system for paying back end commissions in accordance with an embodiment of the invention.

### DETAILED DESCRIPTION OF THE DRAWINGS

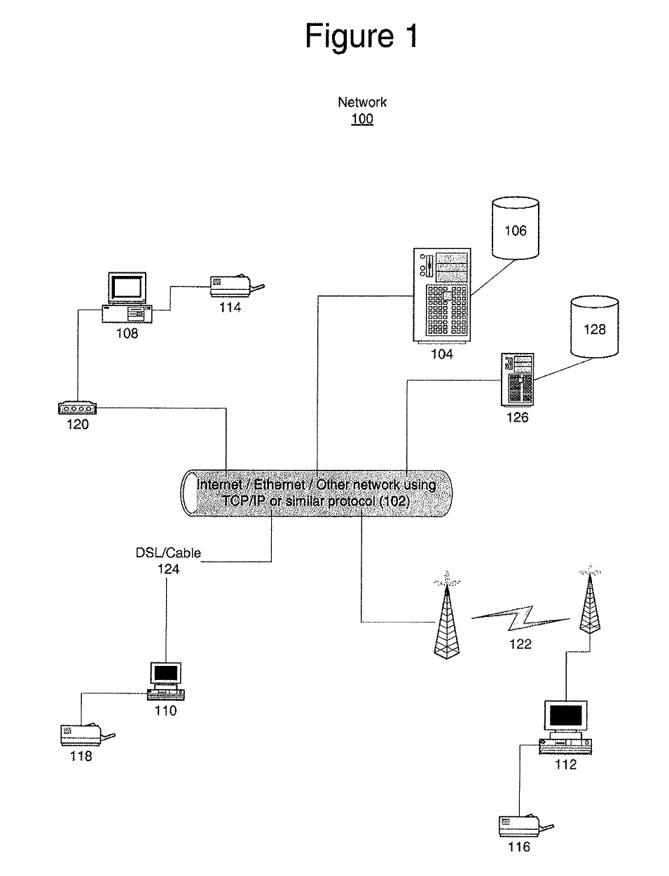

With reference now to the figures, FIG. 1 is a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Network data processing system 100 might also contain a supplementary server 126 and additional data storage 128.

Clients 108, 110, and 112 are clients to server 104. Network data processing system 100 includes printers 114, 116, and 118, and may also include additional servers, clients, and other devices not shown. The means by which clients 108-112 connect to the network 102 may include conventional telephone landline 120, broadband Digital Service Line (DSL) or cable 124, or wireless communication network 122.

In the depicted example, network data processing system 100 is the Internet with network 102 representing a worldwide collection of networks and gateways that use the TCP/IP suite or similar protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

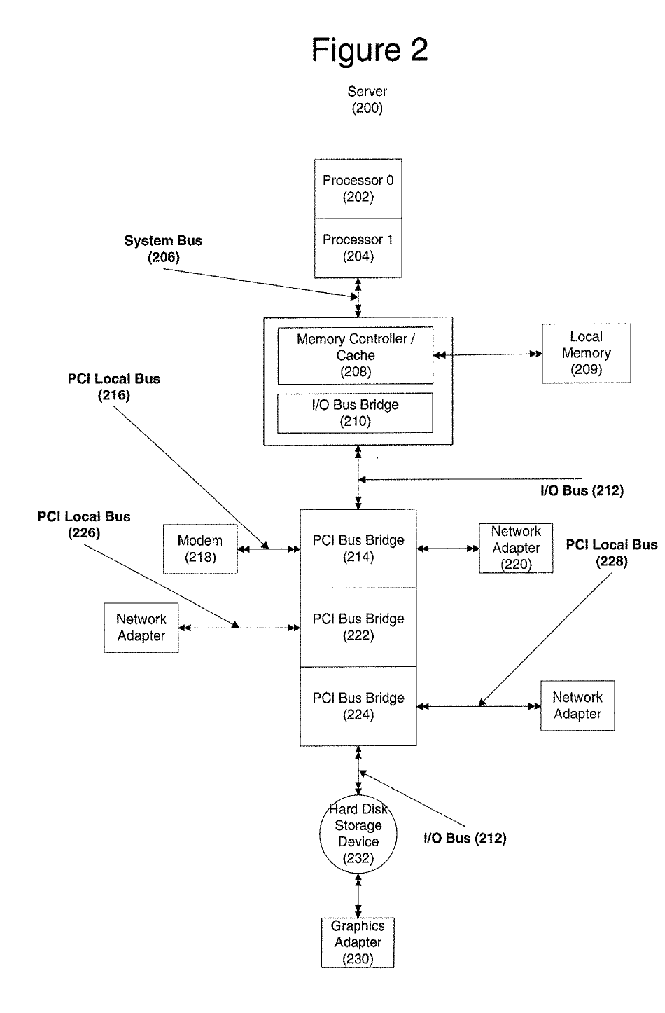

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communication links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

The invention provides a way to automatically track and then pay the retailer and/or distributor for the sale of products. A distribution identifier uniquely identifies the particular wholesaler, retailer or distributor that actually provides the product to a customer.

In the event that the customer purchases an item, the identifier is used to track the supply chain of from the manufacturer to the retailer. The distribution identifier information can be looked up based on product, serial number or some other number or code.

Depending on the compensation system employed, payment for the product sale can move either up or down the supply chain. In one embodiment, the retailer receives payment from the end user. In this case, an invoice is generated by the manufacturer and the retailer distributes a specified percentage of the product sale to each party in the supply chain back to the manufacturer. This is the payment system applicable to most convention retail distribution systems. In an alternate embodiment, payment is made from the end user directly to the manufacturer. In this case, the manufacturer pays commissions to each party in the supply chain up to the retail seller.

The following list of definitions will help the reader better understand the descriptions of the process flows below:
Target Product—The marketed product that will be tracked by the system
UPID (Unique Product Identification): A unique identifier for the Target Product
UCID (Unique Copy Identification): A unique identifier for each copy of a Target Product—UCID are globally unique
Supply Chain Company: Any company involved in the distribution of the Target Product (including both Wholesale and Retail distribution companies)
USCID (Unique Supply Chain company Identification): A unique identifier for a participating Supply Chain Company

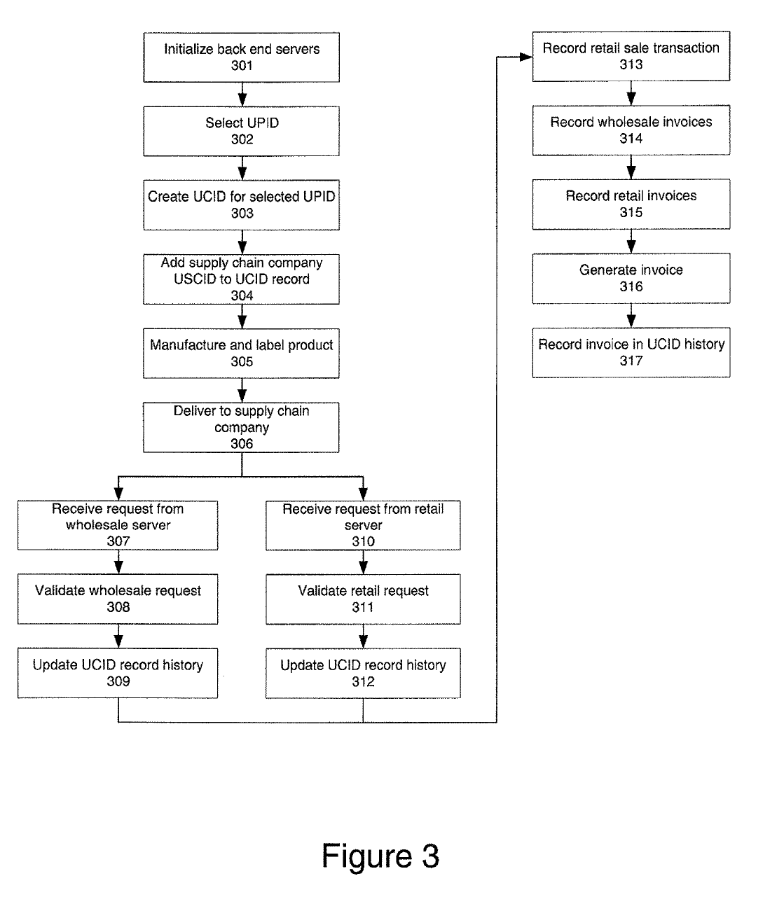

FIG. 3 illustrates a process flow for a billing system in accordance with an embodiment of the present invention. The process begins by initializing the back-end servers (step 301). This involves preparing the database server by selecting the database software of choice. The database is created with associated tables for storing the following information:
UPID associated product information
UCID associated UPID copy information
USCID associated company information
UCID history information

The next steps comprises the pre-shipping (manufacture) transactions. For a new product, a new entry is created in the UPID table (step 302). For an existing product, an active UPID would be selected from the UPID table.

A new UCID record is created for the selected UPID (step 303), and the initial Supply Chain Company is selected and its USCID is stored in the UCID record, which is added to the UCID table (step 304). The USCID is added as RetailInvoice in the UCID record history.

The product identified by the UPID is then manufactured, and that copy is then labeled with its own UCID (step 305) and delivered to the supply chain company identified by the USCID (step 306). The UCID labeling for each item can be accomplished using a variety of techniques known in the art. In the preferred embodiment of the present invention, radio frequency identification (RFID) is incorporated into the packaging or labeling of each item. However, alternate embodiments may incorporate more conventional identification methods such as bar codes, serial numbers, and magnetic strips.

As the item in question moves through the supply chain, the USCID of each successive supply chain company to take possession of the item is stored in the UCID record history. The process may include optional steps for wholesale transactions. The supply chain inventory server receives a request from a supply chain wholesale server (step 307). The inventory server validates the request by looking up the UCID record and identifying the requesting server (step 308). The inventory server then updates the UCID record history (step 309).

The steps for retail transactions start with the inventory server receiving a request from a supply chain retail server (step 310). The inventory server validates the request by looking up the UCID record and identifying the requesting retail server (step 311). The inventory server then updates the UCID record history and records the payment information (step 312).

When the item is finally sold to an end user by a retailer, the transaction is validated and recorded in the UCID record history for that item (step 313). In the preferred embodiment, this would be accomplished via a RFID reader at the retail point of sale (POS) that would read the UCID of the item. As pointed out above, other well known identification techniques may also be used at the POS.

An invoicing server records the wholesale invoices in the accounting system (step 314). These are derived by assessing the USCIDs in the UCID record history and the wholesale invoicing scale associated with the product UPID. The server also records the retail invoice in the accounting system (step 315). This is derived by assessing the Retail USCID in the UCID record history and the retail invoicing scale of the UPID.

The invention periodically generates an invoice (e.g., daily, weekly, monthly, etc.) (step 316). The accounting system processes an invoice history of un-invoiced UCIDs and prepares invoices accordingly. The accounting system then records the invoice in the UCID record history (step 317).

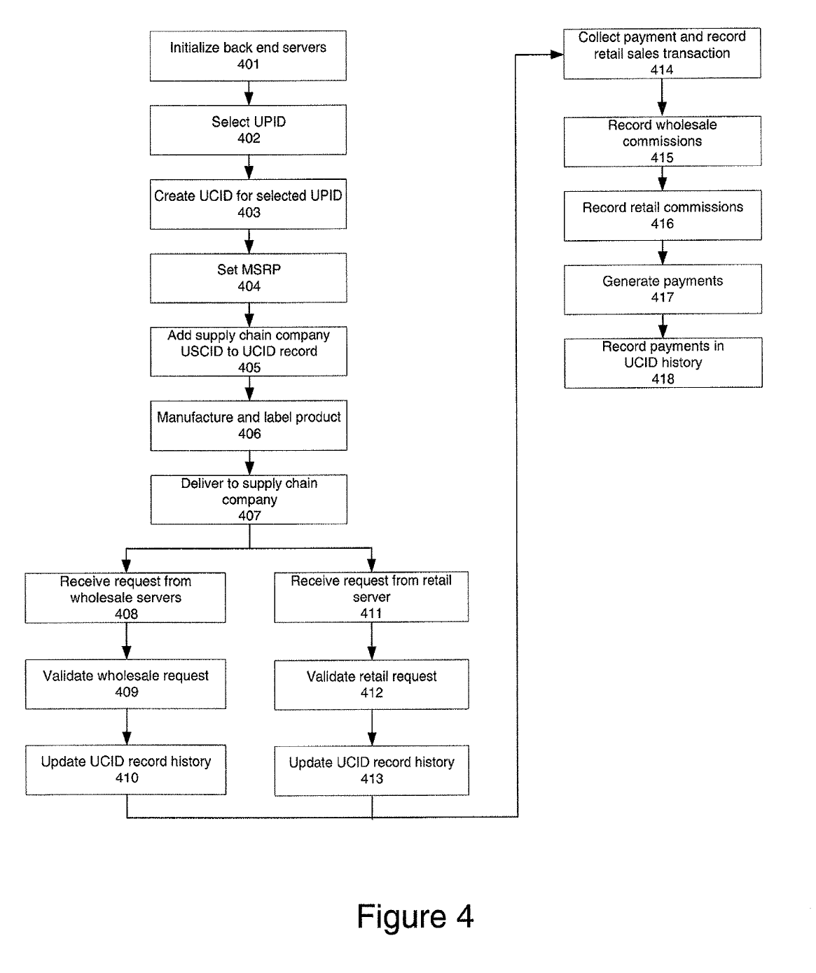

FIG. 4 shows the process flow for using the billing system for paying back end commissions in accordance with an embodiment of the invention. Many of the steps for this process are similar to that of the invoicing process in FIG. 4. However, in this case, the end result is a commission payment from the manufacturer to retailers and/or wholesaler in the supply chain.

The process begins by initializing the back-end servers (step 401). This involves preparing the database server by selecting the database software of choice. The database is created with associated tables for storing the following information:
UPID associated product information
UCID associated UPID copy information
USCID associated company information
UCID history information

The next steps comprises the pre-shipping (manufacture) transactions. A new entry is created in the UPID table for a new product (step 402). For an existing product, an active UPID would be selected from the UPID table.

A new UCID record is created for the selected UPID (step 403), and a Manufacturer Suggested Retail Price (MSRP) is set in the UCID record (step 404). The MSRP is used for calculating the proper commission(s) for the supplier(s) in the supply and distribution chain as well as determining the amount to collect from the end user during the retail transaction.

The initial Supply Chain Company is selected and its USCID is stored in the UCID record, which is added to the UCID table (step 405).

The product identified by the UPID is then manufactured, and that copy is then labeled with its own UCID (step 406) and delivered to the supply chain company identified by the USCID (step 407). As before the UCID labeling and tracking for each item can be accomplished using a variety of techniques known in the art. In the preferred embodiment RFID is used, but more conventional identification methods such as bar codes, serial numbers, and magnetic strips may also be employed.

As with the previous process described above, the USCID of each successive supply chain company to take possession of the item is stored in the UCID record history as the item in question moves through the supply chain. The commission payment process may also include optional steps for wholesale transactions. The supply chain inventory server receives a request from a supply chain wholesale server (step 408). The inventory server validates the request by looking up the UCID record and identifying the requesting server (step 409). The inventory server then updates the UCID record history (step 410).

The steps for retail transactions start with the inventory server receiving a request from a supply chain retail server (step 411). The inventory server validates the request by looking up the UCID record and identifying the requesting retail server (step 412). The inventory server then updates the UCID record history and records the payment information (step 413).

When the item is finally sold to an end user by a retailer, payment is collected directly by the back end system and the transaction is validated and recorded in the UCID record history for that item (step 414). In the preferred embodiment, the recordation would be accomplished via a RFID reader at the retail point of sale (POS) that reads the UCID of the item. Other well known identification techniques may also be used at the POS.

An accounting server records the wholesale commissions in the accounting system (step 415). These are derived by assessing the USCIDs in the UCID record history and the wholesale commission scale associated with the product UPID. The server also records the retail commission in the accounting system (step 416). This is derived by assessing the Retail USCID in the UCID record history and the retail commission scale of the UPID.

The invention periodically generates payments to the supply chain (e.g., daily, weekly, monthly, etc.) (step 417). The accounting system processes a commission history of unpaid UCIDs and prepares commission payments accordingly. The accounting system then records the payment in the UCID record history (step 418).

In the preferred embodiment of the present invention, the manufacturer retains ownership of the product until it is sold to the end user by the retailer. This arrangement is facilitated by the detailed tracking of each item through the entire supply chain from the manufacturer to the end user. Furthermore, having the manufacturer retain ownership of the merchandise until final sale may have tax benefits for distributors and retailers since the merchandise is not their inventory but that of the manufacturer.

The invention also has the benefit of the allowing the manufacturer to very precisely track the distribution path of each item sold and determine the most efficient distribution routes for particular products and well as the most effective distributors and sellers. Precise invoicing and payment of commissions throughout the supply chain also allows efficient distributors and providers to better internalize the benefits produced from their operations.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A method for distributing merchandise, the method comprising the computer implemented steps of:
(a) assigning a unique identifier to a product;
(b) assigning unique identifiers a plurality of product distributors;
(c) selling a copy of said product from the manufacturer to an end user through at least one of said distributors, wherein said copy has a unique identifier;
(d) validating and recording the purchase of said copy of the product by said end user by reading the unique identifier for said copy at a point of sale;
(e) matching the unique identifier of said copy of the product with the unique identifiers of all distributors who were involved in supplying said copy to said end user in step (c); and
(f) paying said distributors identified in step (e) according to a predetermined schedule.

2. The method according to claim 1, wherein step (d) further comprises reading the unique identifier of said copy via RFID at the point of sale.

3. The method according to claim 1, wherein if payment is sent directly to the manufacturer for the purchase of said copy of the product, step (f) further comprises paying commissions from the manufacturer to the distributors identified in step (e).

4. The method according to claim 1, wherein if the end user pays a retail distributor for the purchase of said copy of the product, step (f) further comprises generating an invoice for said retailer detailing payments due from the retailer to the distributors identified in step (e) and the manufacturer.

5. The method according to claim 1, wherein the manufacturer retains ownership of said copy of the product until said copy is sold to the end user.

6. A computer program product in a computer readable medium, for distributing merchandise, the computer program product comprising:
(a) first instructions for assigning a unique identifier to a product;
(b) second instructions for assigning unique identifiers a plurality of product distributors;
(c) third instructions for validating and recording the purchase of a copy of the product by an end user, wherein said copy the product is sold from the manufacturer to the end user through at least one of said distributors, wherein said copy has a unique identifier that is read at the point of sale;
(d) fourth instructions for matching the unique identifier of said copy of the product with the unique identifiers of all distributors who were involved in supplying said copy to said end user in part (c); and
(e) fifth instructions for calculating payments to said distributors identified by fifth instructions (d) according to a pre-determined schedule.

7. The computer program product according to claim 6, wherein the third instructions (c) further comprise instructions for reading the unique identifier of said copy via RFID at the point of sale.

8. The computer program product according to claim 6, wherein if payment is sent directly to the manufacturer for the purchase of said copy of the product, fifth instructions (e) further comprise instructions for paying commissions from the manufacturer to the distributors identified by fourth instructions (d).

9. The computer program product according to claim 6, wherein if the end user pays a retail distributor for the purchase of said copy of the product, fifth instructions (e) further comprise instructions for generating an invoice for said retailer detailing payments due from the retailer to the distributors identified by fourth instructions (d) and the manufacturer.

10. The computer program product according to claim 6, wherein the manufacturer retains ownership of said copy of the product until said copy is sold to the end user.

11. A system for distributing merchandise, the system comprising:
(a) a product database that assigns a unique identifier to a product;
(b) a distributor database that assigning unique identifiers a plurality of product distributors;
(c) a validation database that validates and records the purchase of a copy of the product by an end user, wherein said copy the product is sold from the manufacturer to the end user through at least one of said distributors, and wherein said copy has a unique identifier that is read at the point of sale;
(d) a sale record database that matches the unique identifier of said copy of the product with the unique identifiers of all distributors who were involved in supplying said copy to said end user in part (c); and
(e) an accounting mechanism that calculates payments to said distributors identified in part (d) according to a pre-determined schedule.

12. The system according to claim 11, further comprising:
a RFID device on said copy of the product; and
a RFID reader at the point of sale that reads the unique identifier of said copy in part (c).

13. The system according to claim 11, wherein if payment is sent directly to the manufacturer for the purchase of said copy of the product, the accounting mechanism in part (e) further comprises a payment mechanism for paying commissions from the manufacturer to the distributors identified in part (d).

14. The system according to claim 1 1, wherein if the end user pays a retail distributor for the purchase of said copy of the digital product, the accounting mechanism in part (e) further comprises an invoicing mechanism for generating an invoice for said retailer detailing payments due from the retailer to the distributors identified in part (d) and the manufacturer.

15. The system according to claim 15, wherein the manufacturer retains ownership of said copy of the product until said copy is sold to the end user.
